(19) United States
(12) Patent Application Publication
(10) Pub. No.: US 2026/0047583 A1
(43) Pub. Date: Feb. 19, 2026

(54) Bacillus Strain and Variants Thereof for Inhibition of Plant Diseases

(71) Applicant: CHR. HANSEN A/S, Hoersholm (DK)

(72) Inventors: Patricia Dominguez CUEVAS, Hoersholm (DK); Edward ROJAS, Hoersholm (DK); Cesar FONSECA, Hoersholm (DK); Iuliana NITA, Hoersholm (DK)

(73) Assignee: CHR. HANSEN A/S, Hoersholm (DK)

(21) Appl. No.: 19/104,438

(22) PCT Filed: Aug. 28, 2023
(86) PCT No.: PCT/EP2023/073487

§ 371 Date: Feb. 18, 2025

(30) Foreign Application Priority Data
Aug. 30, 2022 (EP) 22192766.8

(51) Int. Cl. A01N 63/22; A01P 3/00

(52) U.S. Cl. CPC A01N 63/22; A01P 3/00

(57) ABSTRACT

The present invention relates to the use of bacteria for inhibition of plant disease. In particular, the present invention relates to the use of a Bacillus amyloliquefaciens strain and variants thereof, capable of inhibiting growth of phytopathogens, such as fungi and oomycetes including Fusarium culmorum, Fusarium oxysporum, Pythium irregulare, Pythium selbyi and Phytophthora sojae.

### TECHNICAL FIELD OF THE INVENTION

The present invention relates to the use of bacteria for inhibition of plant disease. In particular, the present invention relates to the use of a Bacillus amyloliquefaciens strain and variants thereof, capable of inhibiting growth of phytopathogens, such as fungi and oomycetes including Fusarium culmorum, Fusarium oxysporum, Pythium irregulare, Pythium selbyi and Phytophthora sojae.

### BACKGROUND OF THE INVENTION

The annual global production of four major crops; maize, wheat, rice and barley, are ca. 1110 million metric tons, ca. 750 million metric tons, ca. 500 million metric tons and ca. 150 million metric tons, respectively. The rapid population growth combined with climate change create a big challenge for crop production and yield globally. On one hand, there is an increasing demand of agricultural yield while on the other hand various biotic and abiotic issues significantly reduce crop production.

Among the plant diseases, fungal and oomycete pathogens are the biggest global threat causing huge losses in agriculture and food production. Fungal and oomycete pathogens residing primarily in the soil and/or at the plant roots, such as Fusarium culmorum, Fusarium oxysporum, Pythium irregulare, Pythium selbyi and Phytophthora sojae, are the origin of devastating various diseases on crops, including cereals, legumes, fruits, vegetables, and ornamentals, causing billions of dollars in economic losses worldwide annually.

Various strategies have been implemented to inhibit and control phytopathogens, including application of chemical fungicides, crop rotation, seed treatment etc. Even though the correct usage of fungicide at an early heading date can reduce diseases, application of fungicides is challenging due to overlapping of different developmental stages within the crop. In contrary, prolonged use of chemically synthesized fungicides reduce microbial biodiversity in soil, increases pathogen resistance and generally degrades the soil quality.

Fusarium culmorum is a soilborne fungal plant pathogen. It causes fusarium head blight (FHB), seedling blight and foot rot on cereal crops and other grasses. It is often present in soils where maize or wheat has been cultivated and can remain in the soil for several seasons. Pre-emergence symptoms include seedling blight and damping-off as well as seed degradation. Post-emergence symptoms are seen as discoloration of stems and root systems and decaying of tillers in cereals. Conventional management of Fusarium culmorum in soil include seed treatment with chemical fungicides and crop rotation with dicotyledonous crops. The FHB disease generally develops late in the season or also during storage of the crops/seeds indicating that early application of fungicides might only be partially effective.

Fusarium oxysporum in a ubiquitous soilborne fungal plant pathogen. It is present in soils all over the world. Although their predominant role in native soils is as soil saprophytes, many strains within the Fusarium oxysporum complex are pathogenic to plants, especially against crops such as banana, cotton, tomato, cucumber and ornamentals. Classical symptoms include plant wilting due to infection of vascular tissue that limits the upwards transport of water and nutrients to the shoot. Infected plants show general yellowing and fast wilting while in mild cases there is growth stunting poor vigor. When inspected, stems show browning or discoloration across the xylem. Conventional management of Fusarium oxysporum in soil include furrow or drench applications with chemical fungicides and crop rotation with monocotyledonous crops.

Pythium are a group of oomycete soil pathogens that infect over 200 species, including cereals, legumes, fruits, vegetables, and ornamentals all over the world. Pythium caused damping-off is one of the leading causes of poor germination and low crop establishment in fields and greenhouses. Some of the most important species of Pythium are Pythium irregulare, Pythium ultimum, Pythium sylvaticum, Pythium selbyi and Pythium arrhenomanes. Pre-emergence symptoms are damping-off or directly seed death, while post-emergence symptoms include browning of roots and stubby roots systems and poor growth. Normal management of Pythium pathogens include seed treatments with chemical oomycides and drainage of fields.

Phytophthora sojae is an oomycete soil pathogen. It infects soybean and other leguminous plants during early growth stages. Phytophthora sojae causes root rot in soybeans reducing plant count and affecting yield. It is found worldwide, often in poorly drained soils. It causes root and stem rot and seedling damping-off. Post-emergence symptoms are seen as brown or black lesions on the tap root or secondary roots, and these lesions are often water-soaked. In the stem, the symptoms include chlorosis and wilting of the stems. Normal management of Phytophthora sojae include seed treatments with chemical oomycides, resistant varieties and crop rotation.

Accordingly, soilborne phytopathogens present a substantial obstacle for production of crops in an environmentally friendly and sustainable manner. In particular, there is a need for providing an effective biocontrol product for use to protect seeds and/or the habitat of plants against phytopathogens in the habitat of the plant.

Plant and soil microbes interact to help each other for their growth and development as well as to maintain the terrestrial eco-system. Plants can also use these growth promoting microbes as weapon against various phytopathogens including fungi and oomycetes as microbes have great potential to produce and secrete various bioactive molecules that can act against the phytopathogens, such as fungal pathogens.

Growth promoting microbes include Bacillus, which are Gram-positive bacteria characterized by having thick cell walls and the absence of outer membranes. Much of the cell wall of Gram-positive bacteria is composed of peptidoglycan. Gram-positive species are divided into groups according to their morphological and biochemical characteristics. The genus Bacillus is belonging to the group of sporulating bacteria. Bacterial spores are one of the most resilient cell types; they resist many environmental changes, withstand dry heat and certain chemical disinfectants and may persist for years on dry land.

Accordingly, Bacillus industrial strains are routinely applied in various plant health products for plantations. Many of these industrial Bacillus strains produce/secrete various classes of bioactive metabolites, for example non-ribosomal polyketide synthases (NRPS), polyketides, siderophores, antibiotics, surfactant, hydrolytic enzymes (e.g., protease, lipase, etc.), volatile compounds, etc.

Lipopeptides (e.g. surfactins, iturins, fengycins and the like) have proved to be efficient bioactive metabolites produced by Bacillus strains to inhibit growth of phytopathogens, e.g. as fungicides against FHB, seedling damping-off, stem rot and root rot. Volatile organic compounds (VOCs) are low molecular weight (<300 Da) and high vapor pressure (≥0.01 kPa at 20° C.) molecules that evaporate easily at normal temperatures and pressures. They can travel far from the production point through air, soils and liquid, and therefore they constitute ideal signaling chemicals. Bacillus volatiles, such as acetoin, 2,3 butanediol, diacetyl, benzene, DMDS, pyrazines and several ketones, such as 2-heptanone, 2-octanone, 2-nonanone, 2-undecanone and 2-tridecanone, play important roles in fungal pathogen biocontrol, with proven effects on mycelium growth and sporulation inhibition. Ketone compounds have been described to inhibit the mycelial growth of filamentous fungi and oomycetes. In addition, other VOCs including acetoin and 2,3-butanediol have been proven to promote plant growth and elicit the plant immune response (ISR).

Furthermore, beside the direct antagonism mechanisms related to the various classes of bioactive metabolites produced by Bacillus strains, some beneficial bacteria can protect plants indirectly through the stimulation of the plant defense mechanisms, also known as induced systemic resistance (ISR). Elicitation of the ISR renders plants more resistant to pathogen infection. Protection resulting from ISR elicited by Bacillus spp. has been reported against both fungal and bacterial pathogens. The induction of enhanced defensive mechanism can be systemic as root treatment with bacteria has been shown to trigger protective effects on above-ground plant parts.

Bacillus bioactive metabolites, such as certain lipopeptides and VOCs, have been shown to both promote plant growth and elicit the ISR response.

However, the available industrial Bacillus strains have potential to be supplemented with even more efficient Bacillus strains for combating phytopathogens, including those causing fungal diseases such as FHB, seedling damping-off, stem rot and root rot. Provision of Bacillus strains with improved efficiency would come with significant economic savings and improve the ability to meet the increasing global demands for crop production as the world population grow.

Thus, there is an unmet need for identifying more efficient strains of Bacillus to combat phytopathogens and methods for their use to improve plant health and yield of crops without utilizing hazardous chemical fungicides. In particular, there is a need for combatting soilborne phytopathogens, such as those of the genus Fusarium, Pythium and Phytophthora.

Hence, it would be advantageous to provide and use Bacillus strains with improved capability of inhibiting phytopathogens, such as Fusarium culmorum , Fusarium oxysporum, Pythium irregulare, Pythium selbyi and Phytophthora sojae. Specifically, it would be advantageous to provide Bacillus strains with high production of antifungal bioactive metabolites, such as lipopeptides, that may be utilized as efficient and climate friendly solutions for improving crop yield.

### SUMMARY OF THE INVENTION

The present invention relates to identification of a Bacillus strain and variants thereof that are effective in inhibiting phytopathogens. In particular, herein is identified a Bacillus strain that may be applied to seeds or the habitat of the plant to significantly improve plant health and growth compared to known biofungicide treatments. Accordingly, the present invention makes available a Bacillus strain to combat phytopathogens, such as Fusarium culmorum, Fusarium oxysporum, Pythium irregulare, Pythium selbyi and Phytophthora sojae to reduce the need for chemical fungicides and oomycides.

Thus, an object of the present invention relates to the provision and use of a Bacillus strain or a composition comprising the same capable of inhibiting plant disease without using chemicals.

Another object of the present invention relates to the use of Bacillus strain with improved lipopeptide production profile for combatting fungal and oomycete pathogen disease in plants.

The Bacillus strain may be readily used for inoculation of seeds and/or for application to the habitat of plants.

Thus, an aspect of the present invention relates to use of a composition for inhibiting growth of one or more phytopathogens on a plant, said composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

Another aspect of the present invention relates to a method of inhibiting growth of one or more phytopathogens on a plant, wherein the method comprises applying to the seed and/or the habitat of said plant a composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

A further aspect of the present invention relates to a kit for use in inhibiting growth of one or more phytopathogens on a plant, said kit comprising:

a composition comprising:
(i) a Bacillus amyloliquefaciens strain or a variant thereof, and/or
(ii) a fermentation product produced by a Bacillus amyloliquefaciens strain or a variant thereof,
   optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

A still further aspect of the present invention relates to a kit comprising:

a composition comprising:
(i) a Bacillus amyloliquefaciens strain or a variant thereof, and/or
(ii) a fermentation product produced by a Bacillus amyloliquefaciens strain or a variant thereof,
   optionally, instructions for use,
   wherein the Bacillus amyloliquefaciens strain is deposited as DSM34003 at Deutsche

Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021, and wherein the kit is for use in inhibiting growth of one or more phytopathogens on a plant.

### BRIEF DESCRIPTION OF THE FIGURES

FIG. 1 shows growth inhibition of phytopathogenic oomycete Pythium irregulare (A), and phytopathogenic filamentous fungi Fusarium culmorum (B) and Fusarium oxysporum (C) by fermentation products from B. amyloliquefaciens strain DSM34003 (herein termed FUNGI-SOL) or from commercial strains. The commercial strains are Bacillus amyloliquefaciens strain QST 713 (Serenade® ASO fungicide, Bayer, USA), Bacillus velezensis type strain FZB42 (RhizoVital®42, ABITEP GmbH, Berlin, Germany), and Bacillus velezensis strain FZB24 (Taegro®, Novozymes/Syngenta, Denmark). Inhibition is displayed as bioactivity levels (ID50).

FIG. 2 quantification of the three lipopeptide families' levels, fengycins, surfactins and iturins, comprised in FUNGI-SOL.

FIG. 3 shows the inhibitory effect of lipopeptides on two different phytopathogenic species. (A) Inhibition of surfactin on F. culmorum (left) and P. irregulare (right). (B)

Inhibition of fengycin on F. culmorum (left) and P. irregulare (right). (C) Inhibition of iturin on F. culmorum (left) and P. irregulare (right).

FIG. 4 shows the inhibitory effect of the combination of surfactin and fengycin on growth of (A) F. culmorum and (B) P. irregulare.

FIG. 5 shows inhibition of F. culmorum by exposure to volatiles emitted by the fermentation product (FUNGI-SOL) of B. amyloliquefaciens strain DSM34003.

FIG. 6 shows in vivo biocontrol of two different phytopathogenic fungi by FUNGI-SOL and commercial strain Serenade. (A) Root lengths of maize seedlings grown in soil infested with Pythium selbyi and treated with Serenade or varying concentrations of FUNGI-SOL. Reference samples were an untreated control sample of maize seedlings not subjected to Pythium selbyi (UTC) and maize seedlings not treated with a Bacillus strain (P. selbyi). (B) Root lengths of soybean seedlings subjected to Phytophthora sojae and treated with Serenade or varying concentrations of FUNGI-SOL. Reference samples were an untreated control sample of soybean seedlings not subjected to Phytophthora sojae (UTC) and soybean seedlings not treated with a Bacillus strain (P. sojae). (C) Exemplary image of samples (UTC, P. selbyi, Serenade, FUNGI-SOL).

FIG. 7 shows in vivo biocontrol of a combination of Pythium irregulare and Phytophthora sojae. (A) Plant dry weight of soybean seedlings grown in soil infested with Pythium irregulare and Phytophthora sojae and treated with Serenade or FUNGI-SOL. Reference samples were an untreated control sample of soybean seedlings not subjected to Pythium irregulare and Phytophthora sojae (UTC) and soybean seedlings not treated with a Bacillus strain (P. irregulare+P. sojae). (B) Exemplary image of samples (UTC, P. irregulare +P. sojae, Serenade, FUNGI-SOL).

### DETAILED DESCRIPTION OF THE INVENTION

### Definitions

Prior to outlining the present invention in more details, a set of terms and conventions is first defined:

### Inhibitory Effect/Inhibition of Growth

In the present context, the term “inhibitory effect” or “inhibition of growth” refers to the ability of a microorganism to kill or reduce the growth of a phytopathogen. Accordingly, the inhibitory effect or inhibition of growth may be determined by quantifying the amount of the phytopathogen upon exposure to the microorganism.

### Phytopathogen

In the present context, the term “phytopathogen” refers to any microorganism that is pathogenic to plants. In particular, phytopathogens include, but are not limited to, fungi, oomycetes, and bacteria.

### Identifying Characteristics

In the present context, the term “identifying characteristics” refers to the phenotype of a microorganism, i.e. the set of observable characteristics or traits of the microorganism. Particularly, the identifying characteristic can be the inhibitory effect on a phytopathogen and/or production of one or more metabolites. The metabolite may be a lipopeptide, such as compounds belonging to the iturins, fengycins and/or surfactins families.

Microorganisms sharing all identifying characteristics can have different non-identical genomic sequences. This may be the case if mutations are silent or conservative, i.e. the new codon gives rise to the same amino acid or the new amino acid have similar biochemical properties (e.g. charge or hydrophobicity), respectively.

### Variant or Variant Strain

In the present context, the term “variant” or “variant strain” refers to a strain which is functionally equivalent to a strain of the invention, e.g. having substantially the same properties (e.g. regarding the inhibitory ability against phytopathogens). Such variants, which may be identified using appropriate screening techniques or by strain development or mutagenesis, are a part of the present invention.

Accordingly, variants strains as referred to herein shares the same identifying characteristics as Bacillus amyloliquefaciens strain DSM34003. Such variant strains may have genotypic modifications to Bacillus amyloliquefaciens strain DSM34003 with no or minor phenotypic changes and are as such also considered to be part of the invention.

### Fermentation Product

In the present context, the term “fermentation product” refers to the bacterial culture containing media components, compounds secreted by the bacterial cells resulting from metabolism, such as lipopeptides, polyketides and enzymes, and products from transformations of compounds present in the media or secreted by the bacterial cells. The fermentation product may also contain bacterial cells, in the vegetative and/or spore form and cell debris.

### Metabolite

In the present context, the term “metabolite” refers to any substance produced as an intermediate or end product by a microorganism. Metabolites can be small molecules of low molecular weight that influence biological processes and impact a variety of functions including, but not limited to, inhibitory effects on pathogens, catalytic activity, defensive mechanisms or other interactions with other organisms.

The metabolites with activity against fungal phytopathogens are, in the present context, termed “bioactive metabolites”. One group of bioactive metabolites are lipopeptides, such as iturins, fengycins and surfactins. Other groups of bioactive metabolites include, but are not limited to, polyketides and volatile compounds (VOCs).

### Habitat

In the present context, the term “habitat” refers to any ecological basis in which a plant may grow. Thus, the habitat includes, but is not limited to, soil, sand, peat, water, media or combinations thereof.

### Plant Biostimulant

In the present context, the term “plant biostimulant” refers to any substance or microorganism applied to plants with the ability to enhance nutrition efficiency, abiotic stress tolerance and/or crop quality traits, regardless of its nutrients content. By extension, plant biostimulants also designate commercial products containing mixtures of such substances and/or microorganisms. Microorganisms with biostimulant properties may be referred to as biostimulant strains.

### Plant Growth Promoting Agent

In the present context, the term “plant growth promoting agent” or “plant growth promoting microorganism” refers to a composition comprising a microorganism and/or the fermentation product produced by the microorganism with the ability to colonize aerial plant surfaces (leaves, stems, flowers, fruits) and/or inner plant tissues and promote plant growth and health by either acting as a biofertilizer, biostimulant, biocontrol agent, or via biological control of plant disease.

### About

Wherever the term “about” is employed herein in the context of amounts, for example absolute amounts, such as numbers, purities, weights, concentrations, sizes, etc., or relative amounts (e.g. percentages, equivalents or ratios), timeframes, and parameters such as temperatures, pressure, etc., it will be appreciated that such variables are approximate and as such may vary by ±10%, for example ±5% and preferably ±2% (e.g. ±1%) from the actual numbers specified. This is the case even if such numbers are presented as percentages in the first place (for example ‘about 10%’ may mean ±10% about the number 10, which is anything between 9% and 11%).

### Bacillus Strain and Variants Thereof

Plantations are globally faced with the challenge of maximizing agricultural yield in order to meet the steep global demands of large quantities of goods produced in an environmentally satisfactory manner. However, phytopathogens remains a significant issue causing devastating losses in yield worldwide. While phytopathogens may be combatted with some effect by application of chemicals such as fungicides, these solutions are not preferred as the applied compounds may have hazardous effects on human and animal health as well as negatively impacting the environment. Therefore, solutions based on application of natural organisms are in demand.

Herein is identified and used a Bacillus strain of the species Bacillus amyloliquefaciens with surprisingly high inhibitory effect on phytopathogens, such as Fusarium culmorum, Fusarium oxysporum, Pythium irregulare, Pythium selbyi and Phytophthora sojae. The Bacillus amyloliquefaciens strain has been deposited as DSM34003 and will be referred to herein also as FUNGI-SOL. It is contemplated that the identified strain of Bacillus amyloliquefaciens will aid in combatting the challenges of improving plant health and crop yield in an environmentally compelling manner.

Thus, an aspect of the present invention relates to use of a composition for inhibiting growth of one or more phytopathogens on a plant, said composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

It is to be understood that Bacillus amyloliquefaciens strains with identical or similar phenotypes also forms part of the invention. These may be obtained by classical strain improvement (CSI) techniques, induced mutagenesis, or directed genome engineering to produce new mutants or variants with identical or similar phenotypes. Such strains may be said to have all of the identifying characteristics of the derivative strains disclosed herein. Accordingly, strains sharing all identifying characteristics can have different non-identical genomic sequences. The identifying characteristics may include, but is not limited to, the ability to inhibit a phytopathogen and/or increased production of one or more metabolites.

Thus, an embodiment of the present invention relates to the use as described herein, wherein a variant of the Bacillus amyloliquefaciens strain encompass all the identifying characteristics of the Bacillus amyloliquefaciens strain.

Another embodiment of the present invention relates to the use as described herein, wherein the identifying characteristics of the Bacillus amyloliquefaciens strain includes the fermentation product comprising metabolites, such as lipopeptides. Preferably, the levels and/or combination of metabolites, such as lipopeptides (iturins, fengycins and surfactins), are more favorable for the inhibition of phytopathogenic fungi than other Bacillus strains.

It is contemplated that application of the Bacillus amyloliquefaciens strain, e.g. in the form of spores, will provide a strong and prolonged inhibitory effect on the phytopathogens as the strain continually produces bioactive metabolites, such as lipopeptides and VOCs, with biofungicidal effect. In particular, it is contemplated that spores of the Bacillus amyloliquefaciens strain subsequent to application, e.g. to the seed or habitat of the plant, will germinate and produce lipopeptides, VOCs and, other bioactive metabolites.

Accordingly, a preferred embodiment of the present invention relates to the use as described herein, wherein the composition comprises the Bacillus amyloliquefaciens strain or a variant thereof.

The Bacillus amyloliquefaciens strain may preferably produce lipopeptides and VOCs. Without being bound by theory, the bioactive metabolites, such as lipopeptides and VOCs, may act in combination to produce an enhanced inhibitory effect on phytopathogens, such as fungi and oomycetes.

Since secreted bioactive metabolites, such as lipopeptides, contribute to the inhibitory activity, the composition may include the fermentation product from the cultivation of said Bacillus amyloliquefaciens strain. The fermentation product may be captured as part of the culture/fermentation medium or culture broth. For some applications it may be desirable to include both the Bacillus amyloliquefaciens strain and the fermentation product produced by the strain in the composition.

Thus, an embodiment of the present invention relates to the use as described herein, wherein the composition comprises the fermentation product produced by the Bacillus amyloliquefaciens strain or a variant thereof.

Another embodiment of the present invention relates to the use as described herein, wherein the composition comprises:
(i) the Bacillus amyloliquefaciens strain or a variant thereof, and
(ii) the fermentation product produced by the Bacillus amyloliquefaciens strain or a variant thereof.

It is demonstrated herein that the FUNGI-SOL composition comprising the Bacillus amyloliquefaciens strain DSM34003 and the respective fermentation product thereof effectively inhibits phytopathogens causing disease to seeds, stems and roots of the plants. The composition may preferably be applied as a coating to the seeds or directly to the habitat of the plant to protect the plant against attacks from phytopathogens. The focused application of the composition on parts of the plant below (including seeds) or just above the surface of the habitat is effective for combatting soilborne phytopathogens. Seeds may be inoculated (i.e. coated) with the composition in any suitable form, such as liquid or powder. Whether used for inoculating seeds or application to the stem, root or habitat of the plant, the contemplated use of the composition can be implemented in most agricultural settings without the need for investment in additional equipment.

Thus, an embodiment of the present invention relates to the use as described herein, wherein the composition is applied to one or more selected from the group consisting of the seed of the plant, the root, the stem, and the habitat of the plant, and combinations thereof.

Another embodiment of the present invention relates to the use as described herein, wherein the composition is applied to the seed of the plant or the habitat of the plant, preferably the seed of the plant.

A further embodiment of the present invention relates to the use as described herein, wherein the habitat is selected from the group consisting of soil, sand, peat, water, and media, and combinations thereof.

A still further embodiment of the present invention relates to the use as described herein, wherein the habitat is soil.

The Bacillus amyloliqufaciens strain disclosed herein have high inhibitory activity against phytopathogens that are known to commonly cause disease to plants and reduce health and yield of crops. These phytopathogens include a range of plant fungal, plant oomycetes and plant bacterial pathogens, and in particular those belonging to the genus Fusarium, Pythium and Phytophthora. Without being bound by theory, it is contemplated that primarily the high production of bioactive metabolites, such as lipopeptides and VOCs, are responsible for the increased antibiotic activity of the Bacillus amyloliquefaciens strain.

Thus, an embodiment of the present invention relates to the use as described herein, wherein the one or more phytopathogens are selected from the group consisting of fungal pathogens, oomycetes pathogens and bacterial pathogens, and combinations thereof.

Another embodiment of the present invention relates to the use as described herein, wherein the one or more phytopathogens are from a genus selected from the group consisting of Fusarium, Pythium, Phytophthora, Botrytis, Erwinia, Dickeya, Agrobacterium, Xanthomonas, Xylella, Candidatus, Sclerotinia, Cercospora/Cercosporidium, Uncinula, Podosphaera, Phomopsis, Alternaria, Pseudomonas, Phakopsora, Aspergillus, Uromyces, Cladosporium, Rhizopus, Penicillium, Rhizoctonia, Macrophomina, Mycosphaerella, Magnaporthe, Monilinia, Colletotrichum, Diaporthe, Corynespora, Gymnosporangium, Schizothyrium, Gloeodes, Botryosphaeria, Neofabraea, Wilsonomyces, Sphaerotheca, Erysiphe, Stagonospora, Venturia, Verticillium, Ustilago, Claviceps, Tilletia, Phoma, Cochliobolus, Gaeumanomyces, Rhychosporium, Biopolaris, and Helminthosporium, and combinations thereof.

Yet another embodiment of the present invention relates to the use as described herein, wherein the one or more phytopathogens are from a species selected from the group consisting of Botrytis cinerea, Botrytis squamosa, Erwinia carotovora, Erwinia amylovora, Dickeya dadantii, Dickeya solani, Agrobacterium tumefaciens, Xanthomonas axonopodis, Xanthomonas campestris pv. carotae, Xanthomonas pruni, Xanthomonas arboricola, Xanthomonas oryzae pv. oryzae, Xylella fastidiosa, Candidatus liberibacter, Fusarium culmorum, Fusarium graminearum, Fusarium oxysporum, Fusarium oxysporum f. sp. Cubense, Fusarium oxysporum f. sp. Lycopersici, Fusarium virguliforme, Sclerotinia sclerotiorum, Sclerotinia minor, Sclerotinia homeocarpa, Uncinula necator, Podosphaera leucotricha, Podosphaera clandestine, Phomopsis viticola, Alternaria tenuissima, Alternaria porri, Alternaria alternate, Alternaria solani, Alternaria tenuis, Pseudomonas syringae pv. Tomato, Phytophthora infestans, Phytophthora parasitica, Phytophthora sojae, Phytophthora capsici, Phytophthora cinnamon, Phytophthora fragariae, Phytophthora ramorum, Phytophthora palmivara, Phytophthora nicotianae, Phakopsora pachyrhizi, Phakopsora meibomiae, Aspergillus flavus, Aspergillus niger, Uromyces appendiculatus, Cladosporium herbarum, Rhizopus arrhizus, Rhizoctonia solani, Rhizoctonia zeae, Rhizoctonia oryzae, Rhizoctonia caritae, Rhizoctonia cerealis, Rhizoctonia crocorum, Rhizoctonia fragariae, Rhizoctonia ramicola, Rhizoctonia rubi, Rhizoctonia leguminicola, Macrophomina phaseolina, Mycosphaerella graminocola, Mycosphaerella fijiensis, Mycosphaerella pomi, Mycosphaerella citri, Magnaporthe oryzae, Magnaporthe grisea, Monilinia fruticola, Monilinia vacciniicorymbosi, Monilinia laxa, Colletotrichum gloeosporiodes, Colletotrichum acutatum, Coletotrichum candidum, Diaporthe citri, Corynespora cassiicola, Gymnosporangium juniperi-virginianae, Schizothyrium pomi, Gloeodes pomigena, Botryosphaeria dothidea, Wilsonomyces carpophilus, Sphaerotheca macularis, Sphaerotheca pannosa, Stagonospora nodorum, Pythium ultimum, Pythium aphanidermatum, Pythium irregulare, Pythium selbyi, Pythium ulosum, Pythium lutriarium, Pythium sylvatium, Venturia inaequalis, Ustilago nuda, Ustilago maydis, Ustilago scitaminea, Claviceps pupurea, Tilletia tritici, Tilletia laevis, Tilletia horrid, Tilletia controversa, Phoma glycinicola, Phoma exigua, Phoma lingam, Cochliobolus sativus, Gaeumanomyces gaminis, Rhychosporium secalis, Helminthosporium secalis, Helminthosporium maydis, Helminthosporium solani, and Helminthosporium triticirepentis, and combinations thereof.

A further embodiment of the present invention relates to the use as described herein, wherein the one or more phytopathogens are one or more fungal pathogens or oomycetes pathogens.

Fungal pathogens of particular importance to the agricultural industry include, but are not limited to, Fusarium culmorum and Fusarium oxysporum. Fusarium culmorum causes the disease Fusarium crown rot that in turn can be devastating to the yield of cereal crops, and Fusarium oxysporum causes systemic yellowing, plant wilting and plant death in vegetable crops. Preventing these fungal pathogens from infecting plants and/or mitigating the detrimental effects on plant already infected are therefore of great importance.

Thus, an embodiment of the present invention relates to the use as described herein, wherein the one or more fungal pathogens are of the genus Fusarium.

Another embodiment of the present invention relates to the use as described herein, wherein the one or more fungal pathogens are Fusarium culmorum and/or Fusarium oxysporum .

Yet another embodiment of the present invention relates to the use as described herein, wherein the one or more fungal pathogens is Fusarium culmorum.

A further embodiment of the present invention relates to the use as described herein, wherein the one or more plant fungal pathogens is Fusarium oxysporum.

Oomycetes pathogens of particular importance to the agricultural industry include, but are not limited to, Pythium irregulare and Phytophthora sojae both causing root and stem rot and seedling damping-off. Preventing these oomycetes pathogens from infecting plants and/or mitigating the detrimental effects on plant already infected will therefore benefit overall plant health and improve yield.

Accordingly, an embodiment of the present invention relates to the use as described herein, wherein the one or more oomycetes pathogens are of the genus Pythium and/or Phytophthora.

Another embodiment of the present invention relates to the use as described herein, wherein the one or more oomycetes pathogens are selected from the group consisting of Pythium irregulare, Pythium selbyi and Phytophthora sojae, and combinations thereof.

A further embodiment of the present invention relates to the use as described herein, wherein the one or more oomycetes pathogens is Pythium selbyi.

A further embodiment of the present invention relates to the use as described herein, wherein the one or more oomycetes pathogens is Phytophthora sojae.

An even further embodiment of the present invention relates to the use as described herein, wherein the one or more phytopathogens are one or more selected from the group consisting of Fusarium culmorum, Fusarium oxysporum, Pythium irregulare, Pythium selbyi and Phytophthora sojae.

Gram-positive bacteria, such as Bacillus, are capable of forming spores, typically in the form of intracellular spores called endospores, as a surviving mechanism. These endospores are very retractile and thick-walled structures that constitute the most dormant form of bacteria as they exhibit minimal metabolism, respiration and enzyme production. Such bacterial spores are highly resistant to temperature fluctuations, chemical agents, UV radiation, pH gradients, drought and nutrition depletion. As the surrounding environment favors bacterial proliferation, the bacterial spores will germinate back into vegetative cells, i.e. an active bacterial cell undergoing metabolism.

Accordingly, spore-forming bacteria are preferred in the present context as they possess the ability to lay dormant if conditions in the field does not favor survival. Thus, the risk of losing the biostimulant Bacillus amyloliquefaciens strain after application to seed, plant or habitat of the plant is reduced for spore-forming bacteria. Accordingly, the Bacillus amyloliquefaciens strain disclosed herein has been positively selected for spore-formation ability.

Therefore, an embodiment of the present invention relates to the use as described herein, wherein the Bacillus amyloliquefaciens strain is in the form of spores or vegetative cells.

The composition may preferably comprise said Bacillus amyloliquefaciens strain in the form of spores as this increases stability and longevity of the composition, especially when applied under harsh conditions, such as drought or the like.

Accordingly, an embodiment of the present invention relates to the use as described herein, wherein the Bacillus amyloliquefaciens strain is in the form of spores.

Bacillus strains produce a range of bioactive metabolites, i.e. those metabolites that are inhibitory to other organisms, like phytopathogenic fungi and oomycetes. One group of bioactive metabolites are the lipopeptides, which consist of a lipid moiety connected to a peptidic moiety. Lipopeptides acts as biosurfactants and may have antibiotic activity, e.g. fungicidal activity. It is contemplated that the Bacillus amyloliquefaciens strain of FUNGI-SOL identified and used herein has a favourable expression and secretion profile of bioactive metabolites which enhance its biofungicide and oomycide effect.

Therefore, an embodiment of the present invention relates to the use as described herein, wherein the fermentation product comprises one or more metabolites.

A group of lipopeptides known to have antibiotic activity are the cyclic lipopeptides. This group includes iturins, fengycins and surfactins, which all share a common structure consisting of a lipid tail linked to a short cyclic peptide. The variants of compounds in each group come from different amino acid components. Iturins and fengycins are known to have strong antifungal activity, whereas surfactins do not on their own exhibit great antifungal toxicity. However, surfactins may promote the antifungal activity of other lipopeptides.

An embodiment of the present invention relates to the use as described herein, wherein the metabolites are lipopeptides.

Another embodiment of the present invention relates to the use as described herein, wherein the lipopeptides are selected from the group consisting of iturins, fengycins and surfactins, and combinations thereof.

The inventors have found that surfactins works synergistically with other lipopeptides, such as fengycins, to produce a strong inhibitory effect on growth of phytopathogens, such as fungal pathogens and/or oomycetes pathogens. Without being bound by theory, it is therefore suggested herein that Bacillus strains promoting elevated levels of surfactins can provide a superior inhibitory effect. Preferably, such a Bacillus strain is capable of producing also increased levels of other lipopeptides, such as fengycins and iturins.

Thus, an embodiment of the present invention relates to the use as described herein, wherein said a Bacillus amyloliquefaciens strain or a variant thereof is capable of producing elevated levels of lipopeptides, such as surfactins, fengycins and/or iturins. Another embodiment of the present invention relates to the use as described herein, wherein said a Bacillus amyloliquefaciens strain or a variant thereof is capable of producing elevated levels of surfactins and/or fengycins, preferably surfactins and fengycins.

A further embodiment of the present invention relates to the use as described herein, wherein the lipopeptides comprise fengycins and iturins.

A still further embodiment of the present invention relates to the use as described herein, wherein the lipopeptides comprise surfactins and fengycins.

An even further embodiment of the present invention relates to the use as described herein, wherein the lipopeptides comprise surfactins and iturins.

The production of the one or more metabolites may be quantified by liquid chromatography-mass spectrometry (LC-MS).

An embodiment of the present invention relates to the use as described herein, wherein the total concentration of lipopeptides in the fermentation product is about 600-1600 μg/ml in a medium originally containing 30 mol/L of carbon source.

It is to be understood that that the total concentration of lipopeptides as used herein refers to the total concentration of surfactins, fengycins and iturins combined.

Another embodiment of the present invention relates to the use as described herein, wherein the concentration of surfactins is about 300-750 μg/ml.

A further embodiment of the present invention relates to the use as described herein, wherein the concentration of fengycins is about 200-500 μg/ml.

A still further embodiment of the present invention relates to the use as described herein, wherein the concentration of iturins is about 100-400 μg/ml.

Volatile organic compounds (VOCs) produced by bacteria travel from their host via air, soil and liquid to interact with microorganisms in the vicinity of the bacteria, including phytopathogenic organisms. Moreover, lipopeptides and VOCs, among other bioactive metabolites, are known to function as biocontrol compounds that can promote plant growth and elicit the induced systemic resistance (ISR) response. Accordingly, it is contemplated that the Bacillus amyloliquefaciens strains or compositions containing those, as described herein, are able to also stimulate ISR in the plants after having been applied to seeds or the habitat of the plant. This effect is substantiated herein in Example 4, which demonstrates the inhibitory effect of VOCs emitted by Bacillus amyloliquefaciens strains DSM34003 on the model fungi F. culmorum.

Therefore, an embodiment of the present invention relates to the use as described herein, wherein the composition comprises one or more volatile organic compounds.

Another embodiment of the present invention relates to the use as described herein, wherein the Bacillus amyloliquefaciens strain or a variant thereof produces one or more volatile organic compounds.

It is contemplated that the combination of bioactive metabolites, such as lipopeptides may be particularly effective in inhibiting phytopathogens. Thus, an embodiment of the present invention relates to the use as described herein, wherein the Bacillus amyloliquefaciens strain or a variant thereof produces more than one bioactive metabolite, such as one or more lipopeptide and one or more volatile organic compound (VOC).

Another embodiment of the present invention relates to the use as described herein, wherein the Bacillus amyloliquefaciens strains or compositions containing those elicit the induced systemic resistance (ISR) response.

The composition comprising the Bacillus amyloliquefaciens strain and/or fermentation product produced by the strain will for most practical purposes also comprise other components to improve stability, deliverability or otherwise improve the performance as a plant growth promoting agent. Many of such additional components may be standard ingredient that are typically used in formulations of plant growth promoting agents, plant biostimulants, or biofungicides.

Therefore, an embodiment of the present invention relates to the use as described herein, wherein the composition further comprises one or more agrochemically acceptable excipients carriers, surfactants, dispersants and yeast extracts.

Besides any agrochemically acceptable standard ingredients, the composition may comprise additional active ingredients. Additional active ingredients may be, but is not necessarily, of different origin than microbial. They can increase the potency of the composition either by supplementing the inhibitory activity of the Bacillus amyloliquefaciens strain and/or the respective fermentation product thereof with a different effect or by working in synergy with the Bacillus amyloliquefaciens strain and/or the respective fermentation product. Different effects include, but are not limited to, inhibition of other phytopathogens, such as insects or nematodes, or stimulating growth by provision of nutrients.

Therefore, an embodiment of the present invention relates to the use as described herein, wherein the composition further comprises one or more active ingredients.

Another embodiment of the present invention relates to the use as described herein, wherein the one or more active ingredients are of microbial, biological or chemical origin.

Yet another embodiment of the present invention relates to the use as described herein, wherein the one or more active ingredients are selected from the group consisting of an insecticide, fungicide, nematicide, bactericide, herbicide, plant extract, plant growth regulator, a plant growth stimulator, and fertilizer.

A further embodiment of the present invention relates to the use as described herein, wherein the insecticide is selected from the group consisting of pyrethroids, bifenthrin, tefluthrin, zeta-cypermethrin, organophosphates, chlorethoxyphos, chlorpyrifos, tebupirimphos, cyfluthrin, fiproles, fipronil, nicotinoids, and clothianidin, and combinations thereof.

A still further embodiment of the present invention relates to the use as described herein, wherein the fungicide is selected from the group consisting of fluopyram plus tebuconazole, chlorothalonil, thiophanate-methyl, prothioconazole, metalaxyl, and copper hydroxide, and combinations thereof.

A preferred variation of the composition combines FUNGI-SOL as disclosed herein with a different strain of bacteria. The second bacterial strain may function as a plant biostimulant or plant growth promoting agent.

Accordingly, an embodiment of the present invention relates to the use as described herein, wherein the one or more active ingredients are selected from a second strain of bacteria different from the Bacillus amyloliquefaciens strain.

Another embodiment of the present invention relates to the use as described herein, wherein said second strain of bacteria is a biostimulant strain, preferably a biostimulant Bacillus strain.

A further embodiment of the present invention relates to the use as described herein, wherein said second strain of bacteria is of a species selected from the group consisting of Bacillus velezensis, Bacillus paralicheniformis, Bacillus amyloliquefaciens, and Bacillus subtilis.

The composition disclosed herein may be in the form of a liquid, a powder, a wettable powder, a granule, a spreadable granule, a wettable granule, a microencapsulation, and a planting matrix or any technically feasible formulation that may include suitable agrochemically acceptable components. Alternatively, the composition may also be provided as an oil formulation, such as a water in oil (W/O) emulsion, an oil in water (O/W) emulsion, a microemulsion, or an oil dispersion.

For seed inoculation the composition may be either liquid or dry. Seed inoculation is a preferred application method of the composition since it reduces the consumption of inocula. Seed coatings include, but is not limited to, seed dressing, film coating, seed encrusting, and seed pelleting. The different seed coatings may be distinguished by the amount of material added to the original seed. Seed dressing typically comprises mainly the biocontrol agent. Film coatings are thin films of approximately 10% of the mass of the seed. Seed encrustings typically amounts to approximately 100 wt % to 500 wt % of the original seed mass, while still leaving the shape discernible. For seed pellets the applied material is so thick that the original shape of the seed is no longer discernible. The choice of coating may depend on type of seed.

Therefore, an embodiment of the present invention relates to the use as described herein, wherein the composition is in a form selected from the group consisting of a liquid, a wettable powder, a granule, a spreadable granule, a wettable granule, and a microencapsulation.

For application of the composition to the seed or habitat of the plant it is preferred that the composition is in liquid form or as a wettable powder.

Another embodiment of the present invention relates to the use as described herein, wherein the composition is a liquid formulation.

A further embodiment of the present invention relates to the use as described herein, wherein the composition is a powder.

A still further embodiment of the present invention relates to the use as described herein, wherein the composition is processed by a technique selected from the group consisting of seed dressing, film coating, seed encrusting, and seed pelleting.

Binders and/or fillers may be part of the composition to improve the coating of seeds. Thus, an embodiment of the present invention relates to the use as described herein, wherein the composition comprises one or more binders and/or fillers.

To further improve the stability and longevity of the Bacillus amyloliquefaciens strain and any other sensitive ingredient or components included in the composition it may benefit to include a coating polymer. Such polymer may shield bacterial strains from hostile environment conditions. In one variation, bacterial spores of the Bacillus amyloliquefaciens strain is coated to improve durability of the microorganism.

Thus, an embodiment of the present invention relates to the use as described herein, wherein the composition further comprises a coating polymer.

Seeds or plants that could be the beneficiary of the inhibitory effect of the composition comprising Bacillus amyloliquefaciens strain and/or the fermentation product thereof on phytopathogens could in principle include any seed or plant that may attract a phytopathogen. Typically, the use of the composition for inhibiting growth of one or more phytopathogens on a seed or plant as disclosed herein is mainly relevant for agriculture, because relatively small improvements in yield can make a great difference in an industrial setting. Moreover, the prospect of being able to improve yield in a climate-friendly manner is attractive and stands in stark contrast to the traditional image of modern agronomy polluting the environment with agrochemicals that cause widespread ecological damage.

Accordingly, an embodiment of the present invention relates to the use as described herein, wherein the plant is selected from the group consisting of a crop, a monocotyledonous plant, a dicotyledonous plant, a tree, an herb, a bush, a grass, a vine, a fern, and a moss.

Within this grouping of plants are found a large and diverse selection of plants that are commercialized in one way or another, which include, but is not limited to, corn, sweet corn, popcorn, seed corn, silage corn, field corn, rice, wheat, barley, sorghum, asparagus, berry, blueberry, blackberry, raspberry, loganberry, huckleberry, cranberry, gooseberry, elderberry, currant, caneberry, bush berry, brassica vegetables, broccoli, cabbage, cauliflower, brussels sprouts, collards, kale, mustard greens, kohlrabi, bulb vegetables, onion, garlic, shallots, citrus, orange, grapefruit, lemon, tangerine, tangelo, pomelo, fruiting vegetables, pepper, avocado, tomato, eggplant, ground cherry, tomatillo, okra, grape, herbs/spices, cucurbit vegetables, cucumber, cantaloupe, melon, muskmelon, squash, watermelon, pumpkin, leafy vegetables, lettuce, celery, spinach, parsley, radicchio, legumes/vegetables (succulent and dried beans and peas), beans, green beans, snap beans, shell beans, soybeans, dry beans, garbanzo beans, lima beans, peas, chick peas, split peas, lentils, oil seed crops, canola, castor, coconut, cotton, flax, oil palm, olive, peanut, rapeseed, safflower, sesame, sunflower, soybean, pome fruit, apple, crabapple, pear, quince, mayhaw, root/tuber and corm vegetables, carrot, potato, sweet potato, beets, ginger, horseradish, radish, ginseng, turnip, stone fruit, apricot, cherry, nectarine, peach, plum, prune, strawberry, tree nuts, almond, pistachio, pecan, walnut, filberts, chestnut, cashew, beechnut, butternut, macadamia, kiwi, banana, agave, tobacco, ornamental plants, poinsettia, hardwood cuttings, oak, maple, sugarcane, sugarbeet, grass, or turf grass. The method of inhibiting growth of one or more phytopathogens on a plant is applicable to any of these plants.

Given the efficiency of the composition disclosed herein against Fusarium, Pythium and Phytophthora, it is preferred to apply the composition to plants that are prone to contract Fusarium crown rot, seedling damping-off, stem rot and root rot.

Thus, an embodiment of the present invention relates to the use as described herein, wherein the plant is selected from the group consisting of maize, soybean, canola, cotton, sunflower, wheat, barley, oats, small cereal grains, rice, sugar cane, potato, tomato, beans, lentils, carrot, coffee and banana.

A preferred embodiment relates to the use as described herein, wherein the plant is maize or soybean.

Based on evidence presented herein, it is contemplated that the use of the composition as disclosed herein will incur many advantageous effects to the plants onto which the composition is applied. Overall, plant health is expected to improve and thereby increase the yield of the crops.

Therefore, an embodiment of the present invention relates to the use as described herein, wherein inhibiting growth of one or more phytopathogens leads to improve seedling vigor, improved root development, improved plant growth, improved plant health, increased yield, improved appearance, reduced pathogenic infection, or a combination thereof.

Another aspect of the present invention relates to a method of inhibiting growth of one or more phytopathogens on a plant, wherein the method comprises applying to the seed and/or the habitat of said plant a composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

The composition comprising the Bacillus amyloliquefaciens strain DSM34003 and/or the fermentation product produced by the strain may conveniently be provided in a container together with any potential other active ingredients that are suitable for use together or sequentially with the composition. Provision of any additional active ingredients may preferably be in separate compartments of the kit (or container) to ensure any adverse effects from long term storage of the composition with the additional ingredients. An example of an adverse effect is inadvertent competition between two different bacterial strains. Instructions may be included to guide the user in application and dosing of the composition and any other active ingredient.

Thus, an aspect of the present invention relates to a kit for use in inhibiting growth of one or more phytopathogens on a plant, said kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

Another aspect of the present invention relates to a kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021, and wherein the kit is for use in inhibiting growth of one or more phytopathogens on a plant.

It is to be understood that the Bacillus strain and/or fermentation product thereof in the kits can be applied to seeds, plant roots, plant stems or the habitat of plants.

The listing or discussion of an apparently prior published document in this specification should not necessarily be taken as an acknowledgement that the document is part of the state of the art or is common general knowledge.

Preferences, options and embodiments for a given aspect, feature or parameter of the invention should, unless the context indicates otherwise, be regarded as having been disclosed in combination with any and all preferences, options and embodiments for all other aspects, features and parameters of the invention. This is especially true for the description of the use of the Bacillus amyloliquefaciens strain and all its features, which may readily be part of the part of the method or kit for inhibiting growth of a phytopathogen on a plant. It is clear from the disclosure herein that the composition may comprise Bacillus amyloliquefaciens strain DSM34003 and/or a fermentation product from the strain. Accordingly, it is to be understood that any discussion of the benefits achieved by use of Bacillus amyloliquefaciens strain DSM34003 can also be extrapolated to the fermentation product or to a combination of the strain and the corresponding fermentation product. Embodiments and features of the present invention are also outlined in the following items.

### Items

X1. Use of a composition for inhibiting growth of one or more phytopathogens on a plant, said composition comprising:
(i) a Bacillus amyloliquefaciens strain or a variant thereof, and/or
(ii) a fermentation product produced by a Bacillus amyloliquefaciens strain or a variant thereof,

wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

X2. The use according to item X1, wherein the composition comprises the Bacillus amyloliquefaciens strain or a variant thereof.

X3. The use according to any one of items X1 or X2, wherein the composition comprises the fermentation product produced by the Bacillus amyloliquefaciens strain or a variant thereof.

X4. The use according to any one of the preceding items, wherein the composition is applied to one or more selected from the group consisting of the seed of the plant, the root, the stem, and the habitat of the plant, and combinations thereof.

X5. The use according to any one of the preceding items, wherein the composition is applied to the seed of the plant or the habitat of the plant, preferably the seed of the plant.

X6. The use according to any one of items X4 or X5, wherein the habitat is selected from the group consisting of soil, sand, peat, water, and media, and combinations thereof.

X7. The use according to any one of items X4-X6, wherein the habitat is soil.

X8. The use according to any one of the preceding items, wherein the one or more phytopathogens are selected from the group consisting of fungal pathogens, oomycetes pathogens and bacterial pathogens, and combinations thereof.

X9. The use according to any one of the preceding items, wherein the one or more phytopathogens are from a genus selected from the group consisting of Fusarium, Pythium, Phytophthora, Botrytis, Erwinia, Dickeya, Agrobacterium, Xanthomonas, Xylella, Candidatus, Sclerotinia, Cercospora/Cercosporidium, Uncinula, Podosphaera, Phomopsis, Alternaria, Pseudomonas, Phakopsora, Aspergillus, Uromyces, Cladosporium, Rhizopus, Penicillium, Rhizoctonia, Macrophomina, Mycosphaerella, Magnaporthe, Monilinia, Colletotrichum, Diaporthe, Corynespora, Gymnosporangium, Schizothyrium, Gloeodes, Botryosphaeria, Neofabraea, Wilsonomyces, Sphaerotheca, Erysiphe, Stagonospora, Venturia, Verticillium, Ustilago, Claviceps, Tilletia, Phoma, Cochliobolus, Gaeumanomyces, Rhychosporium, Biopolaris, and Helminthosporium, and combinations thereof.

X10. The use according to any one of the preceding items, wherein the one or more phytopathogens are from a species selected from the group consisting of Botrytis cinerea, Botrytis squamosa, Erwinia carotovora, Erwinia amylovora, Dickeya dadantii, Dickeya solani, Agrobacterium tumefaciens, Xanthomonas axonopodis, Xanthomonas campestris pv. carotae, Xanthomonas pruni, Xanthomonas arboricola, Xanthomonas oryzae pv. oryzae, Xylella fastidiosa, Candidatus liberibacter, Fusarium culmorum, Fusarium graminearum, Fusarium oxysporum, Fusarium oxysporum f. sp. Cubense, Fusarium oxysporum f. sp. Lycopersici, Fusarium virguliforme, Sclerotinia sclerotiorum, Sclerotinia minor, Sclerotinia homeocarpa, Uncinula necator, Podosphaera leucotricha, Podosphaera clandestine, Phomopsis viticola, Alternaria tenuissima, Alternaria porri, Alternaria alternate, Alternaria solani, Alternaria tenuis, Pseudomonas syringae pv. Tomato, Phytophthora infestans, Phytophthora parasitica, Phytophthora sojae, Phytophthora capsici, Phytophthora cinnamon, Phytophthora fragariae, Phytophthora ramorum, Phytophthora palmivara, Phytophthora nicotianae, Phakopsora pachyrhizi, Phakopsora meibomiae, Aspergillus flavus, Aspergillus niger, Uromyces appendiculatus, Cladosporium herbarum, Rhizopus arrhizus, Rhizoctonia solani, Rhizoctonia zeae, Rhizoctonia oryzae, Rhizoctonia caritae, Rhizoctonia cerealis, Rhizoctonia crocorum, Rhizoctonia fragariae, Rhizoctonia ramicola, Rhizoctonia rubi, Rhizoctonia leguminicola, Macrophomina phaseolina, Mycosphaerella graminocola, Mycosphaerella fijiensis, Mycosphaerella pomi, Mycosphaerella citri, Magnaporthe oryzae, Magnaporthe grisea, Monilinia fruticola, Monilinia vacciniicorymbosi, Monilinia laxa, Colletotrichum gloeosporiodes, Colletotrichum acutatum, Coletotrichum candidum, Diaporthe citri, Corynespora cassiicola, Gymnosporangium juniperi-virginianae, Schizothyrium pomi, Gloeodes pomigena, Botryosphaeria dothidea, Wilsonomyces carpophilus, Sphaerotheca macularis, Sphaerotheca pannosa, Stagonospora nodorum, Pythium ultimum, Pythium aphanidermatum, Pythium irregulare, Pythium selbyi, Pythium ulosum, Pythium lutriarium, Pythium sylvatium, Venturia inaequalis, Ustilago nuda, Ustilago maydis, Ustilago scitaminea, Claviceps pupurea, Tilletia tritici, Tilletia laevis, Tilletia horrid, Tilletia controversa, Phoma glycinicola, Phoma exigua, Phoma lingam, Cochliobolus sativus, Gaeumanomyces gaminis, Rhychosporium secalis, Helminthosporium secalis, Helminthosporium maydis, Helminthosporium solani, and Helminthosporium triticirepentis, and combinations thereof.

X11. The use according to any one of the preceding items, wherein the one or more phytopathogens are one or more fungal pathogens or oomycetes pathogens.

X12. The use according to any one of items X8-X11, wherein the one or more fungal pathogens are of the genus Fusarium.

X13. The use according to any one of items X8-X12, wherein the one or more fungal pathogens are Fusarium culmorum and/or Fusarium oxysporum.

X14. The use according to any one of items X8-X13, wherein the one or more oomycetes pathogens are of the genus Pythium and/or Phytophthora.

X15. The use according to any one of items X8-X14, wherein the one or more oomycetes pathogens are selected from the group consisting of Pythium irregulare, Pythium selbyi and Phytophthora sojae, and combinations thereof.

X16. The use according to any one of the preceding items, wherein the Bacillus amyloliquefaciens strain is in the form of spores or vegetative cells.

X17. The use according to any one of the preceding items, wherein the Bacillus amyloliquefaciens strain is in the form of spores.

X18. The use according to any one of the preceding items, wherein the fermentation product comprises one or more metabolites.

X19. The use according to item X18, wherein the metabolites are lipopeptides.

X20. The use according to item X19, wherein the lipopeptides are selected from the group consisting of iturins, fengycins and surfactins, and combinations thereof.

X21. The use according to any of items X19 or X20, wherein the lipopeptides comprise fengycins and iturins.

X22. The use according to any of items X19 or X20, wherein the lipopeptides comprise surfactins and fengycins.

X23. The use according to any of items X19 or X20, wherein the lipopeptides comprise surfactins and iturins.

X24. The use according to any of items X19-X23, wherein the total concentration of lipopeptides in the fermentation product is about 600-1600 μg/ml in a medium originally containing 30 mol/L of carbon source.

X25. The use according to any of items X20-X24, wherein the concentration of surfactins is about 300-750 μg/ml.

X26. The use according to any of items X20-X25, wherein the concentration of fengycins is about 200-500 μg/ml.

X27. The use according to any of items X20-X26, wherein the concentration of iturins is about 100-400 μg/ml.

X28. The use according to any one of the preceding items, wherein the Bacillus amyloliquefaciens strain or a variant thereof produces one or more volatile organic compounds.

X29. The use according to any one of the preceding items, wherein the composition further comprises one or more agrochemically acceptable excipients carriers, surfactants, dispersants and yeast extracts.

X30. The use according to any one of the preceding items, wherein the composition further comprises one or more active ingredients.

X31. The use according to item X30, wherein the one or more active ingredients are of microbial, biological or chemical origin.

X32. The use according to any one of items X30 or X31, wherein the one or more active ingredients are selected from the group consisting of an insecticide, fungicide, nematicide, bactericide, herbicide, plant extract, plant growth regulator, a plant growth stimulator, and fertilizer.

X33. The use according to item X32, wherein the insecticide is selected from the group consisting of pyrethroids, bifenthrin, tefluthrin, zeta-cypermethrin, organophosphates, chlorethoxyphos, chlorpyrifos, tebupirimphos, cyfluthrin, fiproles, fipronil, nicotinoids, and clothianidin, and combinations thereof.

X34. The use according to any one of items X32 or X33, wherein the fungicide is selected from the group consisting of fluopyram plus tebuconazole, chlorothalonil, thiophanate-methyl, prothioconazole, metalaxyl, and copper hydroxide, and combinations thereof.

X35. The use according to any one of items X30-X34, wherein the one or more active ingredients are selected from a second strain of bacteria different from the Bacillus amyloliquefaciens strain.

X36. The use according item X35, wherein said second strain of bacteria is a biostimulant strain, preferably a biostimulant Bacillus strain.

X37. The use according to any one of items X35 or X36, wherein said second strain of bacteria is of a species selected from the group consisting of Bacillus velezensis, Bacillus paralicheniformis, Bacillus amyloliquefaciens, and Bacillus subtilis.

X38. The use according to any one of the preceding items, wherein the composition is in a form selected from the group consisting of a liquid, a powder, a wettable powder, a granule, a spreadable granule, a wettable granule, and a microencapsulation.

X39. The use according to any one of the preceding items, wherein the composition is a liquid formulation.

X40. The use according to any one of the preceding items, wherein the composition further comprises a coating polymer.

X41. The use according to any one of the preceding items, wherein the plant is selected from the group consisting of a crop, a monocotyledonous plant, a dicotyledonous plant, a tree, an herb, a bush, a grass, a vine, a fern, and a moss.

X42. The use according to any one of the preceding items, wherein the plant is selected from the group consisting of maize, soybean, canola, cotton, sunflower, wheat, barley, oats, small cereal grains, rice, sugar cane, potato, tomato, beans, lentils carrot, coffee and banana.

X43. The use according to any one of the preceding items, wherein inhibiting growth of one or more phytopathogens leads to improve seedling vigor, improved root development, improved plant growth, improved plant health, increased yield, improved appearance, reduced pathogenic infection, or a combination thereof.

Y1. A method of inhibiting growth of one or more phytopathogens on a plant, wherein the method comprises applying to the seed and/or the habitat of said plant a composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

Y2. The method according to item Y1, wherein the composition comprises the Bacillus amyloliquefaciens strain or a variant thereof.

Y3. The method according to any one of items Y1 or Y2, wherein the composition comprises the fermentation product produced by the Bacillus amyloliquefaciens strain or a variant thereof.

Y4. The method according to any one of items Y1-Y3, wherein the composition is applied to the seed of the plant.

Y5. The method according to any one of items Y1-Y4, wherein the composition is applied to habitat of the plant.

Y6. The method according to any one of items Y4 or Y5, wherein the habitat is selected from the group consisting of soil, sand, peat, water, and media, and combinations thereof.

Y7. The method according to any one of items Y4-Y6, wherein the habitat is soil.

Y8. The method according to any one of items Y1-Y7, wherein the one or more phytopathogens are selected from the group consisting of fungal pathogens, oomycetes pathogens and bacterial pathogens, and combinations thereof.

Y9. The method according to any one of items Y1-Y8, wherein the one or more phytopathogens are from a genus selected from the group consisting of Fusarium, Pythium, Phytophthora, Botrytis, Erwinia, Dickeya, Agrobacterium, Xanthomonas, Xylella, Candidatus, Sclerotinia, Cercospora/Cercosporidium, Uncinula, Podosphaera, Phomopsis, Alternaria, Pseudomonas, Phakopsora, Aspergillus, Uromyces, Cladosporium, Rhizopus, Penicillium, Rhizoctonia, Macrophomina, Mycosphaerella, Magnaporthe, Monilinia, Colletotrichum, Diaporthe, Corynespora, Gymnosporangium, Schizothyrium, Gloeodes, Botryosphaeria, Neofabraea, Wilsonomyces, Sphaerotheca, Erysiphe, Stagonospora, Venturia, Verticillium, Ustilago, Claviceps, Tilletia, Phoma, Cochliobolus, Gaeumanomyces, Rhychosporium, Biopolaris, and Helminthosporium, and combinations thereof.

Y10. The method according to any one of items Y1-Y9, wherein the one or more phytopathogens are from a species selected from the group consisting of Botrytis cinerea, Botrytis squamosa, Erwinia carotovora, Erwinia amylovora, Dickeya dadantii, Dickeya solani, Agrobacterium tumefaciens, Xanthomonas axonopodis, Xanthomonas campestris pv. carotae, Xanthomonas pruni, Xanthomonas arboricola, Xanthomonas oryzae pv. oryzae, Xylella fastidiosa, Candidatus liberibacter, Fusarium culmorum,

Fusarium graminearum, Fusarium oxysporum, Fusarium oxysporum f. sp. Cubense, Fusarium oxysporum f. sp. Lycopersici, Fusarium virguliforme, Sclerotinia sclerotiorum, Sclerotinia minor, Sclerotinia homeocarpa, Uncinula necator, Podosphaera leucotricha, Podosphaera clandestine, Phomopsis viticola, Alternaria tenuissima, Alternaria porri, Alternaria alternate, Alternaria solani, Alternaria tenuis, Pseudomonas syringae pv. Tomato, Phytophthora infestans, Phytophthora parasitica, Phytophthora sojae, Phytophthora capsici, Phytophthora cinnamon, Phytophthora fragariae, Phytophthora ramorum, Phytophthora palmivara, Phytophthora nicotianae, Phakopsora pachyrhizi, Phakopsora meibomiae, Aspergillus flavus, Aspergillus niger, Uromyces appendiculatus, Cladosporium herbarum, Rhizopus arrhizus, Rhizoctonia solani, Rhizoctonia zeae, Rhizoctonia oryzae, Rhizoctonia caritae, Rhizoctonia cerealis, Rhizoctonia crocorum, Rhizoctonia fragariae, Rhizoctonia ramicola, Rhizoctonia rubi, Rhizoctonia leguminicola, Macrophomina phaseolina, Mycosphaerella graminocola, Mycosphaerella fijiensis, Mycosphaerella pomi, Mycosphaerella citri, Magnaporthe oryzae, Magnaporthe grisea, Monilinia fruticola, Monilinia vacciniicorymbosi, Monilinia laxa, Colletotrichum gloeosporiodes, Colletotrichum acutatum, Coletotrichum candidum, Diaporthe citri, Corynespora cassiicola, Gymnosporangium juniperi-virginianae, Schizothyrium pomi, Gloeodes pomigena, Botryosphaeria dothidea, Wilsonomyces carpophilus, Sphaerotheca macularis, Sphaerotheca pannosa, Stagonospora nodorum, Pythium ultimum, Pythium aphanidermatum, Pythium irregulare, Pythium selbyi, Pythium ulosum, Pythium lutriarium, Pythium sylvatium, Venturia inaequalis, Ustilago nuda, Ustilago maydis, Ustilago scitaminea, Claviceps pupurea, Tilletia tritici, Tilletia laevis, Tilletia horrid, Tilletia controversa, Phoma glycinicola, Phoma exigua, Phoma lingam, Cochliobolus sativus, Gaeumanomyces gaminis, Rhychosporium secalis, Helminthosporium secalis, Helminthosporium maydis, Helminthosporium solani, and Helminthosporium triticirepentis, and combinations thereof.

Y11. The method according to any one of items Y1-Y10, wherein the one or more phytopathogens are one or more fungal pathogens or oomycetes pathogens.

Y12. The method according to any one of items Y8-Y11, wherein the one or more fungal pathogens are of the genus Fusarium.

Y13. The method according to any one of items Y8-Y12, wherein the one or more fungal pathogens are Fusarium culmorum and/or Fusarium oxysporum.

Y14. The method according to any one of items Y8-Y13, wherein the one or more oomycetes pathogens are of the genus Pythium and/or Phytophthora.

Y15. The method according to any one of items Y8-Y14 wherein the one or more oomycetes pathogens are selected from the group consisting of Pythium irregulare, Pythium selbyi and Phytophthora sojae, and combinations thereof.

Y16. The method according to any one of items Y1-Y15, wherein the Bacillus amyloliquefaciens strain is in the form of spores or vegetative cells.

Y17. The method according to any one of items Y1-Y16, wherein the Bacillus amyloliquefaciens strain is in the form of spores.

Y18. The method according to any one of items Y1-Y17, wherein the fermentation product comprises one or more metabolites.

Y19. The method according to item Y18, wherein the metabolites are lipopeptides.

Y20. The method according to item Y19, wherein the lipopeptides are selected from the group consisting of iturins, fengycins and surfactins, and combinations thereof.

Y21. The method according to any of items Y19 or Y20, wherein the lipopeptides comprise fengycins and iturins.

Y22. The method according to any of items Y19 or Y20, wherein the lipopeptides comprise surfactins and fengycins.

Y23. The method according to any of items Y19 or Y20, wherein the lipopeptides comprise surfactins and iturins.

Y24. The method according to any of items Y19-Y23, wherein the total concentration of lipopeptides in the fermentation product is about 600-1600 μg/ml in a medium originally containing 30 mol/L of carbon source.

Y25. The method according to any of items Y20-Y24, wherein the concentration of surfactins is about 300-750 μg/ml.

Y26. The method according to any of items Y20-Y25, wherein the concentration of fengycins is about 200-500 μg/ml.

Y27. The method according to any of items Y20-Y26, wherein the concentration of iturins is about 100-400 μg/ml.

Y28. The method according to any one of items Y1-Y27, wherein the Bacillus amyloliquefaciens strain or a variant thereof produces one or more volatile organic compounds.

Y29. The method according to any one of items Y1-Y28, wherein the composition further comprises one or more agrochemically acceptable excipients carriers, surfactants, dispersants and yeast extracts.

Y30. The method according to any one of items Y1-Y29, wherein the composition further comprises one or more active ingredients.

Y31. The method according to item Y30, wherein the one or more active ingredients are of microbial, biological or chemical origin.

Y32. The method according to any one of items Y30 or Y31, wherein the one or more active ingredients are selected from the group consisting of an insecticide, fungicide, nematicide, bactericide, herbicide, plant extract, plant growth regulator, a plant growth stimulator, and fertilizer.

Y33. The method according to item Y32, wherein the insecticide is selected from the group consisting of pyrethroids, bifenthrin, tefluthrin, zeta-cypermethrin, organophosphates, chlorethoxyphos, chlorpyrifos, tebupirimphos, cyfluthrin, fiproles, fipronil, nicotinoids, and clothianidin, and combinations thereof.

Y34. The method according to any one of items Y32 or Y33, wherein the fungicide is selected from the group consisting of fluopyram plus tebuconazole, chlorothalonil, thiophanate-methyl, prothioconazole, metalaxyl, and copper hydroxide, and combinations thereof.

Y35. The method according to any one of items Y30-Y34, wherein the one or more active ingredients are selected from a second strain of bacteria different from the Bacillus amyloliquefaciens strain.

y36. The method according to item Y35, wherein said second strain of bacteria is a biostimulant strain, preferably a biostimulant Bacillus strain.

Y37. The method according to any one of items Y35 or Y36, wherein said second strain of bacteria is of a species selected from the group consisting of Bacillus velezensis, Bacillus paralicheniformis, Bacillus amyloliquefaciens, and Bacillus subtilis.

Y38. The method according to any one of items Y1-Y37, wherein the composition is in a form selected from the group consisting of a liquid, a powder, a wettable powder, a granule, a spreadable granule, a wettable granule, and a microencapsulation.

Y39. The method according to any one of items Y1-Y38, wherein the composition is a liquid formulation.

Y40. The method according to any one of items Y1-Y39, wherein the composition further comprises a coating polymer.

Y41. The method according to any one of items Y1-Y40, wherein the plant is selected from the group consisting of a crop, a monocotyledonous plant, a dicotyledonous plant, a tree, an herb, a bush, a grass, a vine, a fern, and a moss.

Y42. The method according to any one of items Y1-Y41, wherein the plant is selected from the group consisting of maize, soybean, canola, cotton, sunflower, wheat, barley, oats, small cereal grains, rice, sugar cane, potato, tomato, beans, lentils carrot, coffee and banana.

Y43. The method according to any one of items Y1-Y42, wherein inhibiting growth of one or more phytopathogens leads to improve seedling vigor, improved root development, improved plant growth, improved plant health, increased yield, improved appearance, reduced pathogenic infection, or a combination thereof.

Z1. A kit for use in inhibiting growth of one or more phytopathogens on a plant, said kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

Q1. A kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021, and wherein the kit is for use in inhibiting growth of one or more phytopathogens on a plant.

The invention will now be described in further details in the following non-limiting examples.

### EXAMPLES

### Example 1: Screening of Bacillus strains for Inhibitory Effect Against Fusarium culmorum

Bacillus spp. are well known biocontrol agents of phytopathogens and have been described to produce a vast array of bioactive metabolites with inhibitory effects over pathogenic species growth. Bacillus strains differ in the genomic potential for biosynthesis of bioactive metabolites and on the respective regulation of gene expression, and therefore can produce different combinations of bioactive metabolites with different inhibitory effects against specific pathogens.

### Method

A high throughput screening scheme was set up to identify Bacillus strains with inhibitory effect on phytopathogens from a library containing 600 candidate Bacillus strains. All strains were screened for inhibitory effect on Fusarium culmorum. The inhibitory potency of Bacillus strains against filamentous fungi was evaluated by two different in vitro methods: one based on co-cultivation, where fungi and bacteria grow together on solid medium, competing for space and nutrients; another based on Bacillus capacity of producing bioactive metabolites and their impact on fungal growth in liquid medium. The two screening methods have been described extensively in Kjeldgaard et al. (2022).

### Results

The inhibition screening campaign identified one primary candidate of the species Bacillus amuloliquefaciens which displayed promising biofungicide properties. The strain has been deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021. The performance of Bacillus amyloliquefaciens strain DSM34003 against a selection of pathogenic fungi is described in the following examples. The fermentation product of the Bacillus amyloliquefaciens strain DSM34003 is referred to as FUNGI-SOL herein.

### Conclusion

The inhibition screening campaign resulted in the identification of main biofungicide candidate Bacillus amyloliquefaciens strain DSM34003.

### Example 2: Effect of FUNGI-SOL on Growth of PHYTOPATHOGENS PYTHIUM irregulare, Fusarium culmorum, and Fusarium oxysporum

The bioactivity of FUNGI-SOL against phytopathogenic oomycete Pythium irregulare and filamentous fungi Fusarium culmorum and Fusarium oxysporum was benchmarked against fermentation products from well-known biocontrol competitor strains, including Bacillus amyloliquefaciens strain QST 713 (Serenade® ASO fungicide, Bayer, USA), Bacillus velezensis type strain FZB42 (RhizoVital®42, ABITEP GmbH, Berlin, Germany) and Bacillus velezensis strain FZB24 (Taegro®, Novozymes/Syngenta, Denmark).

### Method

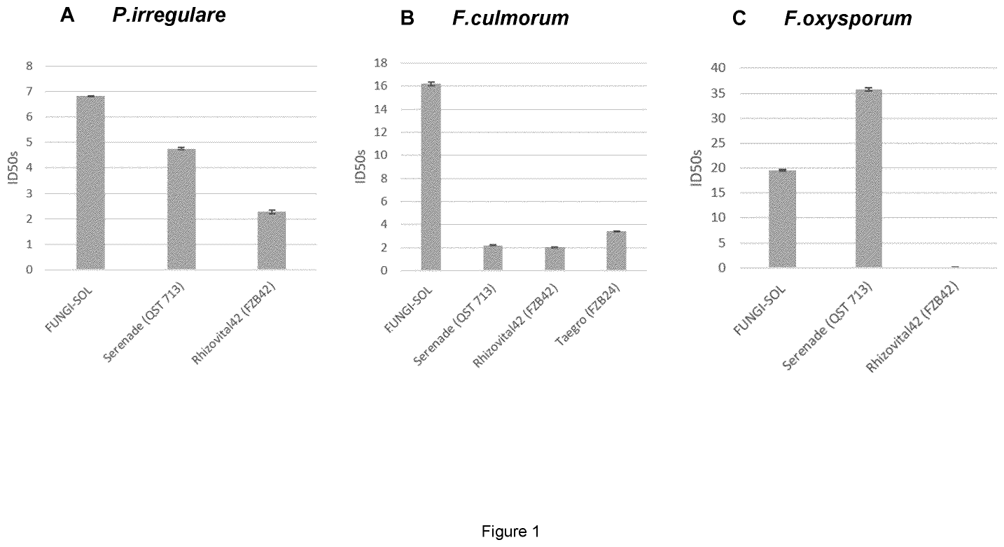

Growth inhibition of phytopathogenic oomycete Pythium irregulare (FIG. 1A), and filamentous fungi Fusarium culmorum (FIG. 1B) and Fusarium oxysporum (FIG. 1C) by metabolites present in bacterial cultures of FUNGI-SOL and commercial strains (Serenade, Rhizovital, Taegro) was performed in LB medium.

A dilution series of bacterial culture samples were added to 48-well microtiter plates containing potato dextrose broth (PDB) medium and a fixed fungal spore concentration. Bacterial growth was inhibited by presence of bacteriostatic antibiotics in the culture medium (Cam and Tet, at 50 and 10 μg/ml, respectively). Plates were incubated at 25° C. without shaking for 60 h (in dark conditions) and fungal growth was measured by spectrophotometry at 600 nm. The dilution factor at which each strain derivative inhibits 50% of the maximal fungal growth (ID50) were used as a measure of inhibition potency. ID50 values were determined by sigmoid regression of experimental data obtained from in vitro fungal inhibition assays with different dilution factors (FIGS. 1A-C).

Experiments were done as biologically independent duplicates and results represented correspond to the averages and standard deviations calculated from results.

### Results

Pythium irregulare, Fusarium culmorum, and Fusarium oxysporum growth inhibition profiles by bacterial cultures compared between FUNGI-SOL and commercial strains (Serenade, Rhizovital, Taegro) showed that the fungal inhibition potential of FUNGI-SOL was higher or similar with well-known biocontrol strains. ID50 values calculated from those experimental results confirmed the superior biocontrol potential of FUNGI-SOL (FIGS. 1A-C).

### Conclusion

Experimental results comparing the inhibition potency of FUNGI-SOL and well described biocontrol strains confirmed the great performance of this strain as biocontrol agent to inhibit the causative agent of root rot and damping off, P. irregulare, and the causative agent of root rot, ear blight, stalk rot, common root rot and other diseases of cereals, F. culmorum and the causative agent of systemic yellowing, wilting, and death in plants, F. oxysporum.

### Example 3: Production of Lipopeptides by FUNGI-SOL and Their Effect on Phytopathogens Growth

FUNGI-SOL was examined with regards to lipopeptide production to elucidate any potential correlation with biofungicide effect. To further explore the potential synergistic effect between bioactive metabolites assays with single families of bioactive compounds and their combinations were performed.

### Methods

### Quantification of Lipopeptides

Samples from FUNGI-SOL were analyzed by LC-MS to quantify and compare the concentrations of the three families of lipopeptides (surfactins, iturins and fengycins).

Biocontrol product samples were first thoroughly mixed by vortexing followed by transfer of 150 μL of culture broth to a 1.5mL Eppendorf tube already containing 40 μL of ₁₃C-labeled bioactive metabolites and 810 μL of isopropanol. The mixture was ultrasonicated for 10 min on ice and mixed in a rotatory mixer for 20 min to ensure an effective extraction of the metabolites. Samples were centrifuged at 15,000 rpm for 3 min at 4° C. and 100 μL of supernatant was used for LC-MS analysis.

### Inhibitory Effect of Lipopeptides

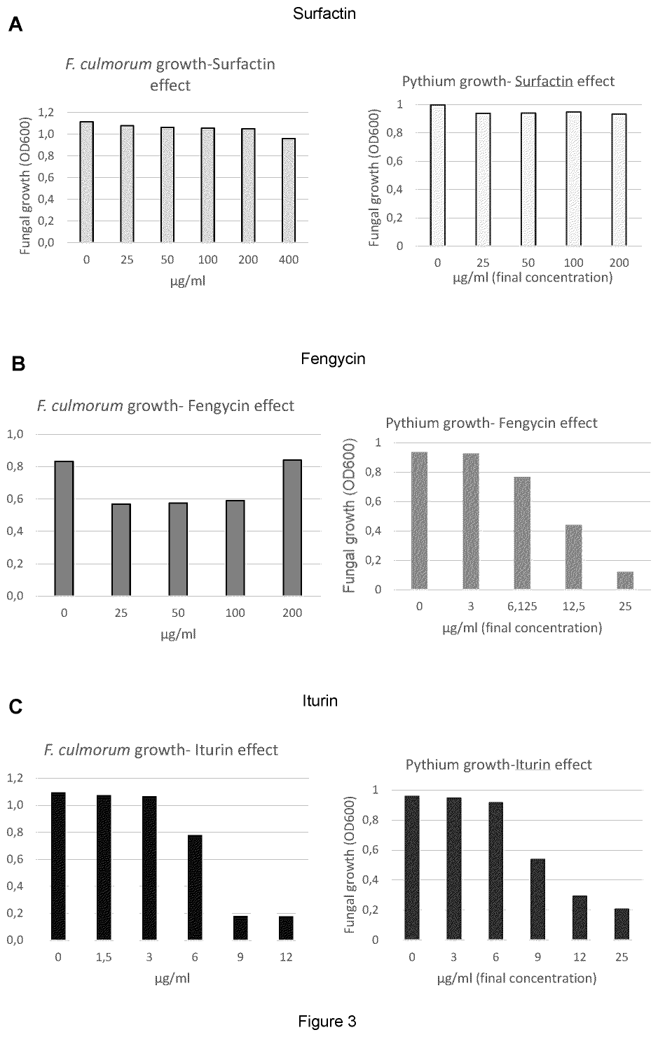

Increasing concentrations of pure stocks of surfactin (Sigma S3523, FIG. 3A), fengycin (Sigma SMB00292, FIG. 3B) or iturin (Sigma 11774, FIG. 3C) were added to 48-well microtiter plates containing PDB medium and a fixed fungal spore concentration. Inhibitory effect over two different phytopathogenic species was assayed, F. culmorum (FIG. 3, left) and P. irregulare (FIG. 3, right). Plates were incubated at 25° C. without shaking for 60 hours (in dark conditions) and fungal growth was measured by spectrophotometry at 600 nm. Experiments were carried out in biological duplicates with no major variations in inhibition potency of the tested strains.

### Results

### Quantification of Lipopeptides

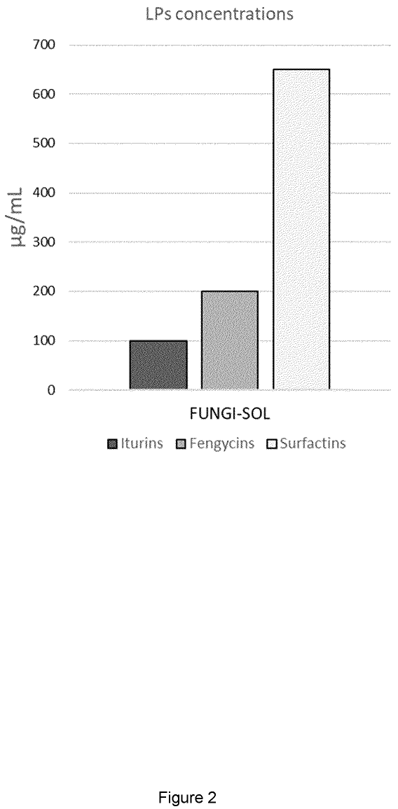

FUNGI-SOL comprised high levels of all lipopeptides (iturins, fengycins and surfactins) (FIG. 2). Given that FUNGI-SOL had higher bioactivity than all the commercial strains (see Example 2), then the inhibitory effect of lipopeptides and their interplay were further investigated.

### Inhibitory EFFECT of Lipopeptides

Both fengycins and iturins showed potent inhibition of fungal growth, while surfactins only compromised pathogen growth very weakly. Iturin addition strongly inhibited the growth of the two phytopathogenic species tested to a very low effective concentration of 9 μg/ml (FIG. 3C). The inhibitory effect of fengycin alone on the growth of the three pathogens was consistently observed, although the concentrations required to reach 50% growth inhibition were higher than for iturin, ranging from 12.5 to 50 μg/ml final concentration (FIG. 3B). This lower potency of inhibition observed for fengycin could potentially be related to lack of solubility of this compound when applied alone to a fungal growth medium. Finally, the inhibitory effect of surfactin was very modest and barely decreased the growth of the pathogens assayed even at high concentrations (200-400 μg/ml) (FIG. 3A).

Combinations of different concentrations of surfactin and fengycin were tested to determine if this combination of lipopeptides could be the origin of the superior performance of FUNGI-SOL. Fungal growth inhibition of increasing concentrations of single compounds was compared with compound combinations, where a fixed concentration of one of them was assayed in combination with increasing concentrations of the second metabolite.

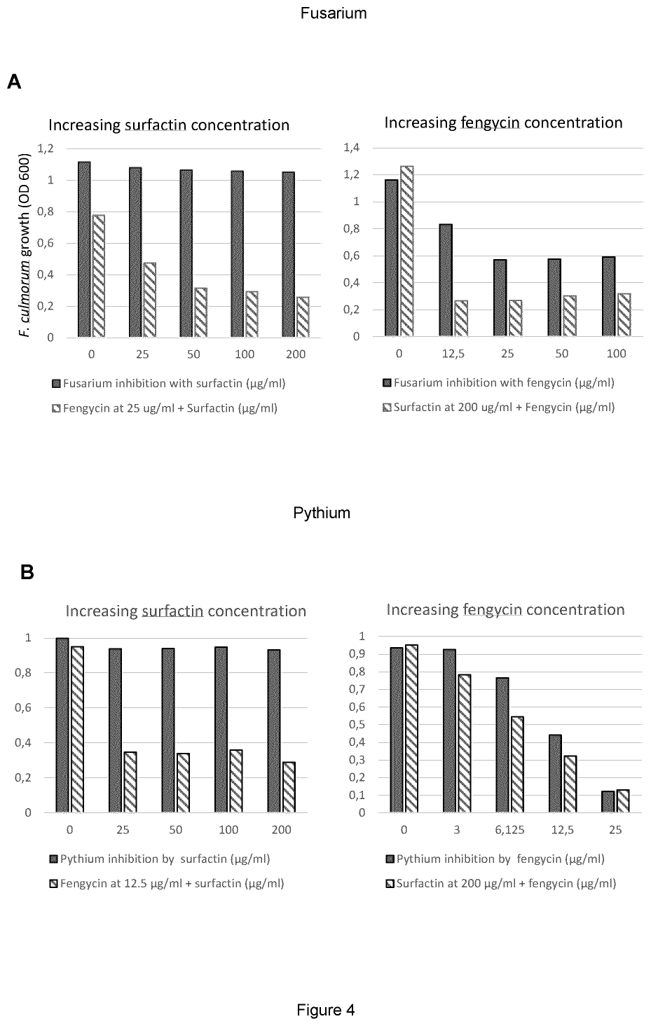

For both F. culmorum and P. irregulare, the bioactivity of fengycin increased up to 6-fold in the presence of surfactin. At surfactin concentrations of 100-200 μg/ml, the effective concentration of fengycin required to inhibit the tested phytopathogens growth decreased to 12.5 μg/ml (FIG. 4, right). The ratio of surfactin/fengycin concentration of 1 to 16 (at >10 μg/ml fengycin) revealed a synergistic inhibitory effect over fungal phytopathogens. The enhanced bioactivity of fengycin could potentially be triggered by other surfactants, either produced by the Bacillus or supplemented to the fermentation process, formulation or application stages.

### Conclusion

This example demonstrates that there is a direct correlation between the higher bioactivity values (ID50) quantified in FUNGI-SOL compared to those of the commercial biocontrol products, and the higher concentrations of bioactive compounds, namely the lipopeptides fengycins, surfactins and iturins. In particular, the combination of surfactin and fengycin generated a synergistic inhibitory effect to fungal growth.

### Example 4: Influence of FUNGI-SOL Volatiles on Phytopathogen Growth

Fungal inhibition by exposure to bacterial volatile organic compounds (VOCs) emitted by Bacillus amyloliquefaciens strain DSM34003 was assayed by measuring the diameter of fungal growing colonies (F. culmorum).

### Methods

Bacillus amyloliquefaciens strain DSM34003 and fungal spores were inoculated on the agar surface of separate PDA filled plates. Two plates, one inoculated with fungal spores and the other with the Bacillus strain were confronted and sealed to avoid escape of VOCs and allow exposure. Confronted and sealed plates were incubated at 25° C., without light exposure for 1-3 days. Fungal growth development was monitored, and diameter measurements of the fungal colonies done every day. Fungal inoculated plates were placed facing upwards to avoid the slimy Bacillus colonies to drip onto the other plate. Control plates, where no bacteria were inoculated on the confronted agar plates, were also incubated and monitored under the same conditions. Results are reported as the average of 3 independent experiments and error bars correspond to the standard deviation.

### Results

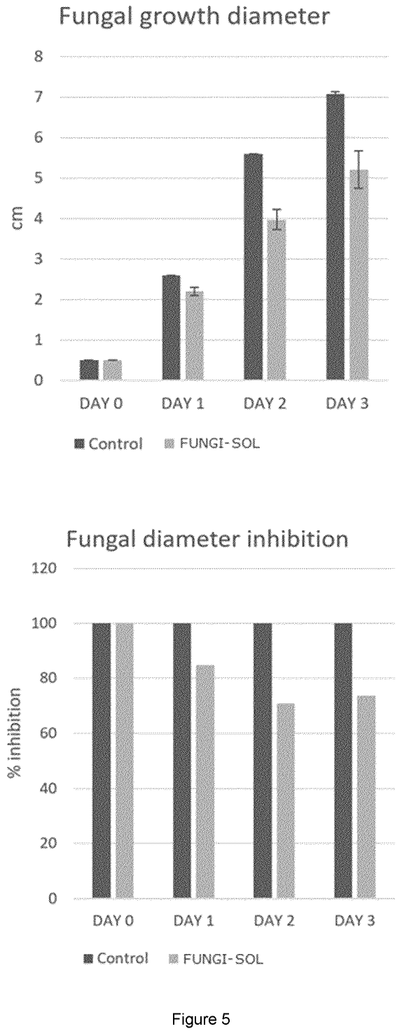

Growth of cultures of F. culmorum were inhibited by the exposure to VOCs from Bacillus amyloliquefaciens strain DSM34003. Overall, fungal colony diameters (in cm) were decreased by approximately 25% over a 3-day period compared to fungal colonies not exposed VOCs from the Bacillus strain (FIG. 5).

### Conclusion

This example demonstrates that VOCs produced by Bacillus amyloliquefaciens strain DSM34003 impact negatively the growth of Fusarium culmorum.

### Example 5: In vivo bioactivity assessment of FUNGI-SOL

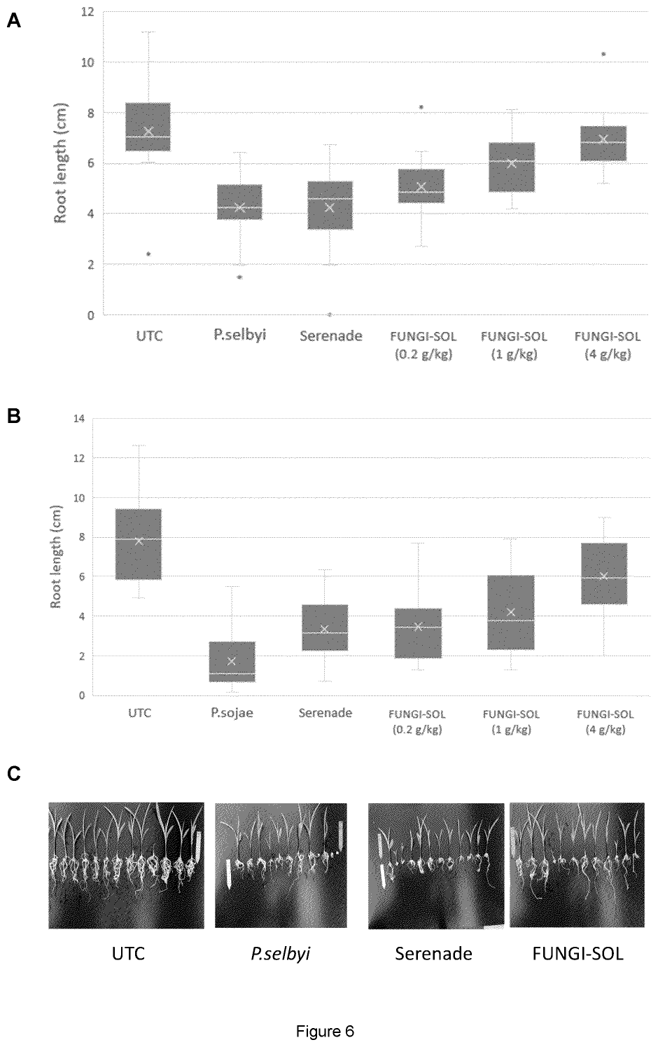

The biofungicidal effect of FUNGI-SOL was tested on maize seedlings growing in soil infested with Pythium selbyi (FIG. 6A) and on soybean seedlings growing in soil infested with Phytophthora sojae (FIG. 6B).

### Methods

Maize seeds (cv Autens KWS) and soybean seeds (cv Abelina) were coated with FUNGI-SOL spores at rates of 0.2, 1 or 4 gr/kg of seeds. The treated seeds were sown in small pots filled with a mixture of sand, water and dried rice colonized by Pythium selbyi (FIG. 6A) or Phytophthora sojae (FIG. 6B) (14 days of growth in incubator, dried and ground to fine powder) at a rate of 3 gr dried rice per kg of sand. Plants were grown in a growth chamber under constant 18-23° C. cycles and 16 hours of light per day for 14 days. The plants were harvested, roots were washed, and photographs were taken for root length assessment using image analysis software ImageJ (FIG. 6C). Root length was measured from the seed to the tip of the longest root.

Experiments with uncoated seeds or seeds coated with Serenade (1 ml/kg of seeds) were run in parallel for comparison. Also, reference samples with seeds sown in non-infected soil was performed as a control.

### Results

The root length of both maize and soybean seedlings were increased when seeds were coated with FUNGI-SOL spores under all dosages compared to non-coated seeds (P.selbyi or P.sojae) (FIGS. 6A-B). In particular, application of FUNGI-SOL to the seeds increased root length with up to approximately 60% and 200% for Pythium and Phytophthora, respectively. Seeds coated with 1 g/kg or 4 g/kg FUNGI-SOL produced longer root lengths than seeds coated with commercial product Serenade (1 mL/kg) and performed at least as good as Serenade (1 mL/kg) down to an application rate of 0.2 g/kg.

### Conclusion

This example demonstrates a significant reduction of Pythium infection on maize seedlings and Phytophthora infection on soybean seedlings when seeds are inoculated with FUNGI-SOL spores. Importantly, application of FUNGI-SOL to the seeds improved root length markedly when compared to the commercially available product Serenade. Accordingly, FUNGI-SOL has demonstrated improved potency as a soil biofungicide.

### Example 6: Assessment of Effect of FUNGI-SOL on Dry Weight of Plants from Inoculated Soybean Seeds

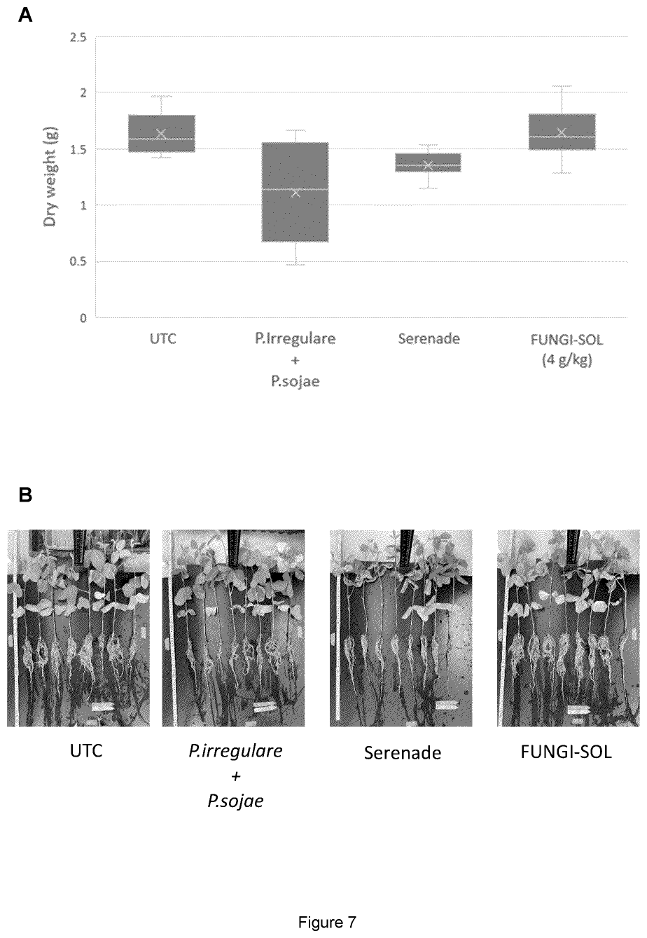

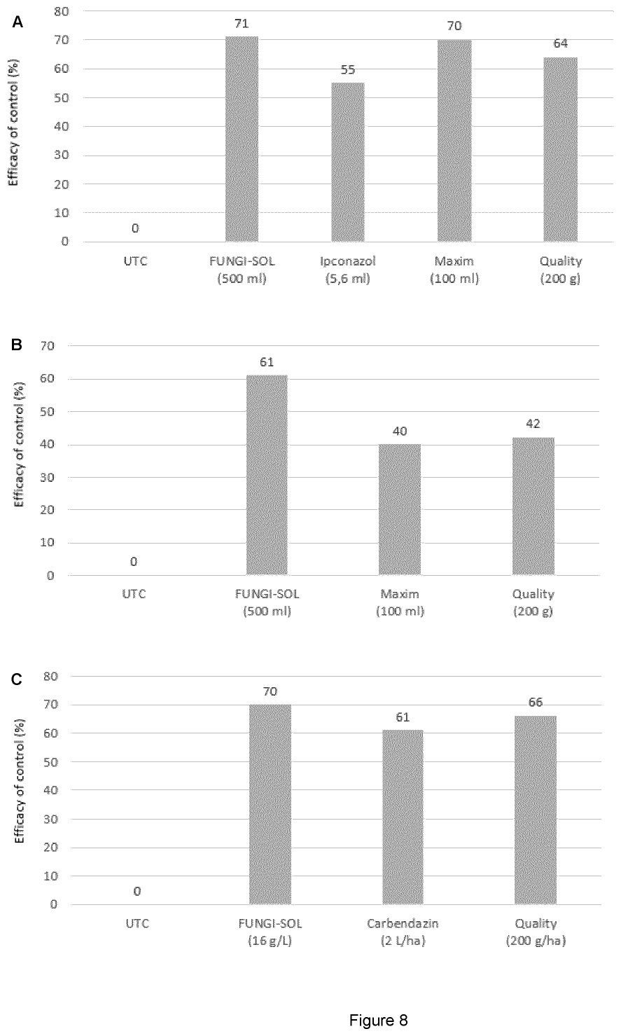

The biofungicidal effect of FUNGI-SOL was evaluated by measuring the plant dry weight of soybean seedlings. Soybean seeds were inoculated with FUNGI-SOL and grown in soil infested with both Pythium irregulare and Phytophthora sojae (FIG. 7) and compared to commercial biocontrol product (Serenade).

### Method

Soybean seeds were coated with FUNGI-SOL spores at 4 gr/kg of seeds rate. The treated seeds were then sown in large pots filled with a mixture of sand, soil, peat and water. A mix of dried rice colonized by Phytophthora sojae and Pythium irregulare (14 days of growth in an incubator, dried and ground to fine powder) was combined at a rate of 5gr dried rice per kg of substrate. Plants were grown in greenhouse at 25° C. for 21 days. The plants were harvested, roots were washed, and plant material was dried at 65° C. for 4 days. The plant dry weight was measured using both roots and shoots.

### Results

The plant dried weight increased when seeds were initially inoculated with FUNGI-SOL spores compared to the non-coated control seeds (P.irregulare+P.sojae). Importantly, inoculation with FUNGI-SOL significantly increased dry weight compared commercially available product Serenade (FIGS. 7A-B).

### Conclusion

This example demonstrates that plant health of plants exposed to Pythium and Phytophthora can be markedly improved by inoculation of the seeds with FUNGI-SOL spores. Accordingly, FUNGI-SOL has demonstrated improved potency as a soil biofungicide.

### Example 7: Assessment of Effect of FUNGI-SOL on Control of Different Soil and Seed Borne Diseases

The FUNGI-SOL can control different soil and seed-borne diseases when applied by seed treatment or in furrow application, providing farmers with more sustainable tool to avoid yield losses.

Fusarium Oxysporum and Macrophomina phaseolina are important seed-borne pathogens that compromise the germination and physiological quality of seeds, causing losses in stand establishment and damping off. Additionally, some isolates of Fusarium are important disease in tomato crop, causing vascular wilt that can severely affect the crop and promoting significant yield losses for farmers.

Biological control has shown itself to be an important tool to control those disease and help farmers to produce more sustainable and healthy food.

### Methods

Three different experiments were performed to test the effect of FUNGI-SOL in different crops challenged with different plant pathogens and compared to the effect of commercially available chemical standard fungicides (Carbendazin, Ipconazol and Maxim) and one biological product (Quality).

The first experiment was conducted by seed treatment application in bean in laboratory conditions. The efficacy level to control Fusarium oxysporum was assessed and compared to chemical fungicides and the biological standard (FIG. 8A). The pathogen was inoculated to stablish good level of disease to evaluate the products properly. The second experiment was conducted in beans against Macrophomina phaseolina under greenhouse conditions. The products were applied as seed treatment (FIG. 8B). In this experiment the pathogen was also inoculated to guarantee good disease pressure. The third experiment was conducted in green house for tomato crop (FIG. 8C). The application was in furrow the moment of seedling transplantation and the pathogen Fusarium sp. was inoculated to make sure and guarantee good disease pressure.

### Results

According to the results, expressed in the FIG. 8A, the FUNGI-SOL at 500 mL/100 Kg of seed showed better control compared to commercial chemical standards like Ipconazol and Maxim. In comparison with biological standards like Quality, FUNGI-SOL showed the same or better performance.

According to the result presented in FIG. 8B FUNGI-SOL provided great efficacy against Macrophomina phaseolina. Efficacy levels of FUNGI-SOL were higher compared to Maxim and Quality market standard products in beans.

According to the results shown in FIG. 8C, FUNGI-SOL provided better control of Fusarium than Carbendazin as a chemical standard in green house for tomato crop. Same good result of FUNGI-SOL was observed when comparing to Quality as a biological standard.

### Conclusion

According to the presented results of three experiments, FUNGI-SOL demonstrated great potential as a biological tool to control and manage Fusarium oxysporum and Macrophomina phaseoline by seed treatment in bean. Through in furrow application

FUNGI-SOL demonstrated very good efficacy to control Fusarium sp. in tomato crop better than commercial standard products.

### REFERENCES

Altschul et al. (1990), J. Mol. Biol., 215, 403-410
Kjeldgaard et al. (2022), Microbiol. Spectr., 10, e0143321

### Deposits and Expert Solution

The applicant requests that a sample of the deposited microorganism stated in table I below may only be made available to an expert, until the date on which the patent is granted.

The applicant requests that the availability of the deposited microorganism referred to in Rule 33 EPC shall be effected only by the issue of a sample to an independent expert nominated by the requester (Rule 32(1) EPC). If an expert solution has been requested, restrictions concerning the furnishing of samples apply.

The deposit was made according to the Budapest treaty on the international recognition of the deposit of microorganisms for the purposes of patent procedure at Deutsche Sammlung von Mikroorganismen und Zellkulturen GmbH (DSMZ), Inhoffenstr. 7B, D-38124 Braunschweig, Germany.

The Budapest Treaty provides that any restriction of public access to samples of deposited biological material must be irrevocably removed as of the date of grant of the relevant patent.

TABLE I
Deposited strain made at a depositary institution.

| Strain | Accession no. | Deposit date |
|---|---|---|
| Bacillus amyloliquefaciens | DSM34003 | 24 Aug. 2021 |

1-15. (canceled)

16. A method comprising introducing into a plant growth medium a Bacillus component selected from:
(a) Bacillus amyloliquefaciens DSM 34003; and
(b) fermentation products produced by Bacillus amyloliquefaciens DSM 34003.

17. The method of claim 16, wherein said Bacillus component comprises spores of Bacillus amyloliquefaciens DSM 34003.

18. The method of claim 16, wherein said Bacillus component comprises a fermentation product produced by Bacillus amyloliquefaciens DSM 34003.

19. The method of claim 16, wherein said Bacillus component is substantially free of bacterial cells and bacterial spores.

20. The method of claim 16, wherein said Bacillus component comprises bioactive metabolites produced by Bacillus amyloliquefaciens DSM 34003.

21. The method of claim 16, wherein said Bacillus component comprises bioactive lipopeptides produced by Bacillus amyloliquefaciens DSM 34003.

22. The method of claim 16, wherein said Bacillus component comprises bioactive iturins, fengycins and surfactins produced by Bacillus amyloliquefaciens DSM 34003.

23. The method of claim 16, wherein said Bacillus component is introduced into said plant growth medium in an amount/concentration sufficient to inhibit growth of one or more fungi in said plant growth medium.

24. The method of claim 16, wherein said Bacillus component is introduced into said plant growth medium in an amount/concentration sufficient to inhibit growth of one or more oomycetes in said plant growth medium.

25. The method of claim 16, wherein said Bacillus component is introduced into said plant growth medium in an amount/concentration sufficient to inhibit growth of one or more Fusarium, Pythium and/or Phytophthora in said plant growth medium.

26. The method of claim 16, wherein said Bacillus component is introduced into said plant growth medium in a liquid carrier.

27. The method of claim 16, wherein said Bacillus component is introduced into said plant growth medium in/on a powder or granule.

28. The method of claim 16, wherein said Bacillus component is introduced into said plant growth medium as part of a plant propagation material that is at least partially coated and/or impregnated with a composition comprising said Bacillus component.

29. A treated seed comprising a plant seed that is at least partially coated with a composition comprising a Bacillus component selected from:
(a) Bacillus amyloliquefaciens DSM 34003; and
(b) fermentation products derived from Bacillus amyloliquefaciens DSM 34003.

30. The treated seed of claim 29, wherein said Bacillus component is present in said composition in an amount sufficient to inhibit growth of one or more phytopathogens when said treated seed is introduced into a plant growth medium.

31. A kit comprising:
a composition comprising a Bacillus component selected from Bacillus amyloliquefaciens DSM 34003 and fermentation products derived from Bacillus amyloliquefaciens DSM 34003; and
instructions for applying said composition to a plant propagation material and/or a plant growth medium.

32. The kit of claim 31, wherein said composition is a liquid.

33. The kit of claim 31, wherein said composition is a powder or granule.

34. The kit of claim 31, wherein said Bacillus component is present in said composition in an amount sufficient to inhibit growth of one or more phytopathogens when said composition is introduced into a plant growth medium.

35. The kit of claim 31, wherein said composition further comprises at least one additional active selected from:
(i) biological pesticides;
(ii) chemical pesticides;
(iii) fertilizers;
(iv) plant biostimulants;
(v) plant growth promoting agents; and
(vi) plant growth regulators.
